(19) United States
(12) Patent Application Publication
(10) Pub. No.: US 2025/0300984 A1
(43) Pub. Date: Sep. 25, 2025

(54) Interactive Content Facilitation in a Cloud-Based Environment

(71) Applicant: Skillz Platform Inc., Las Vegas, NV (US)

(72) Inventors: Thomas Michael Fallon, San Francisco, CA (US); Alex Lacerda, Las Vegas, NV (US); Ekal Golas, San Jose, CA (US); Feijie Zhou, Richmond (CA); Mehul Mittal, Foster City, CA (US)

(21) Appl. No.: 19/084,249

(22) Filed: Mar. 19, 2025

Related U.S. Application Data
(60) Provisional application No. 63/567,407, filed on Mar. 19, 2024.

(51) Int. Cl. H04L 9/40; A63F 13/355; H04L 67/10; H04L 67/131

(52) U.S. Cl. CPC H04L 63/10; A63F 13/355; H04L 67/10; H04L 67/131

(57) ABSTRACT

A network can control the operation of multiple cloud-based applications to facilitate the coordination of live stream events across multiple client devices. The network can receive data characterizing live streams of digital content representing content instances running on cloud-based applications. The content instances can include a common gameplay session. A content event can be generated based on the common gameplay session, the content event including the live streams of digital content. Spectators can request access to the content event and permission can be granted by validating an identifier. Once access is granted to the content event, the live stream data can be output on a display. Related apparatus, systems, techniques, and articles are also described.

### RELATED APPLICATIONS

This application claims the benefit of U.S. Provisional Application No. 63/567,407, filed Mar. 19, 2024, the entire contents of each of which are hereby incorporated by reference herein.

### TECHNICAL FIELD

The subject matter described herein relates to interactive content facilitation in a cloud-based environment.

### BACKGROUND

Software applications are designed to operate across various devices of varying capabilities. Some applications are interactive, providing users with access to various functionalities such as real-time news, text and image messaging, social interactions, online gaming, and so forth. For example, technological advances in hardware and software have led to improvements in interactive digital online games. These digital online games, such as online video games, can be played over a network on a computing device, such as a computer, mobile device, or a video game console. Many of these digital online games require skill and strategy and corporate social aspects that extend beyond the core gameplay experience. Due to their social nature, many digital online games are inherently competitive. For example, online multiplayer games allow players to compete head-to-head in tournaments or for the highest score on the leaderboard.

These digital games are often designed to be accessed by users on client devices of varying capabilities and functionalities. These can include smartphones operating on different software platforms, personal computers (PCs), laptops, video game consoles, and so forth. Typically, these digital games can run natively as a client application on their client device or streamed through a web browser on the client device. While these client applications can provide users with the ability to access and play highly complex digital games against other users on their respective devices, these applications can lack features that enable users to spectate and interact with a live digital game being played by other players in real-time.

### SUMMARY

In an aspect, data can be received from a first client device, the data characterizing a first live stream of digital content representing a first content instance operating as part of a first instance of a cloud-based application, the first instance of the cloud-based application executing within an environment specific to the first client device. Data can be received from a second client device, the data characterizing a second stream of digital content representing a second content instance operating as part of a second instance of the cloud-based application, the second instance of the cloud-based application executing within an environment specific to the second client device, wherein the first content instance executing on the first client device and the second content instance executing on a second client device include a common gameplay session. A content event can be generated based on the common gameplay session, the content event including at least the first live stream of digital content and the second live stream of digital content. Data can be received from a third client device, the data characterizing a request to access the content event and an identifier from a third instance of the cloud-based application. Based on the received data from the third content instance, permission to access the content event can be determined by at least validating the identifier. In response to determining permission to access the content event, data can be transmitted characterizing the content event to the third instance for output on a display communicatively coupled to the third client device.

One or more of the following features can be included in any feasible combination. For example, generating the content event based on the common gameplay session can further comprise scheduling a match associated with the content event at a scheduled time, the match including the first content instance and the second content instance. At a scheduled time, the first instance can be assigned to the first instance of the cloud-based application and the second instance can be assigned to the second instance of the cloud-based application. Transmitting data characterizing the content event to the third instance can further comprise transmitting data characterizing the first live stream of digital content or data characterizing the second live stream of digital content to the third instance for output on the display. Transmitting data characterizing the content event to the third instance can further comprise determining, in real-time, a score associated with the content event. The score can be transmitted to the third instance for output on the display. Determining the score and transmitting the score can be performed continuously for the duration of the content event.

Transmitting data characterizing the content event to the third instance can further comprise partitioning at least the first live stream of the digital content into a plurality of segments, each of the each of the plurality of segments corresponding to a predefined timeframe. The one or more of the plurality of segments can be stored locally in memory. The one or more of the plurality of segments of the first live stream of digital content can be transmitted to the third instance for output on the display. The one or more of the plurality of segments can be deleted from memory after the content event has concluded.

Partitioning at least the first live stream of the digital content into a plurality of segments can further comprise determining a variation in a score in the content event that satisfies a threshold. One or more of the plurality of segments of the first live stream of digital content can be identified that correspond to the variation in the score that satisfies the threshold. The first content instance can correspond to a first digital game instance operating as part of the first instance of the cloud-based application. The second content instance can correspond to a second digital game instance operating as part of the second instance of the cloud-based application; wherein the first digital game instance and the second digital game instance include the common gameplay session. The third content instance can correspond to an interactive graphical interface operating as part of the third instance of the cloud-based application. The interactive graphical interface can comprise a live chat.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating an example embodiment of a method for coordinating live stream events across multiple client devices;

FIG. 2 illustrates an example embodiment of a system that can coordinating live stream events across multiple client devices;

FIG. 3 is a system diagram illustrating an embodiment of the first client device and first spectating device from FIG. 2;

FIG. 4 is a data flow diagram illustrating an example embodiment of data exchanged between a first client device and a network during a live stream event;

FIG. 5 is a data flow diagram illustrating an example embodiment of data exchanged between a first spectating device and the network during a live stream event;

FIG. 6 depicts a digital content page output on a display of the first client device, according to some aspects described and illustrated herein;

FIG. 7 depicts a digital content page output on a display of the first spectating device, according to some aspects described and illustrated herein;

FIG. 8 depicts another digital content page output on a display of the first spectating device, according to some aspects described and illustrated herein;

FIG. 9 is a schematic diagram illustrating one embodiment of a computing device configured in one or more of the systems of FIG. 2.

Like reference symbols in the various drawings indicate like elements.

### DETAILED DESCRIPTION

Online digital games are often designed and optimized for users with devices of varying capabilities and functionalities. Some online digital games are inherently competitive and support competitive matches and tournaments between different players. These competitive online matches can attract live and online audiences (e.g. spectators) to watch the competitive matches unfold.

Some client applications enable users to participate in these sophisticated online digital games against other users on their respective devices. While these applications can provide users with a number of ways to play a digital game, such enabling players to compete while one player is on a PC and the other player is on a mobile device, these applications can lack features that enable users to passively participate in the digital game. Specifically, these applications lack features that allows spectators to view and interact with a live digital game being played between a first player and a second player in real-time. For example, some client applications can require players to rely on third-party streaming applications to live stream their games. However, relying on these third-party applications can introduce latency, reduced video quality, increased computational overhead, and/or additional software installations. Further, in a competitive match between two players, if only one player is live streaming their match, this can lead to a disjointed and one-sided experience.

Additionally, third-party streaming applications typically require sophisticated server infrastructures to handle the network traffic between players and spectators. For example, network serves typically navigate and distribute live stream data to multiple spectators. To efficiently manage many concurrent live streams, the server infrastructure can be highly complex and capable of handling significant network load. For example, the servers typically process, encode, and distribute multiple live video streams in real-time while maintaining low latency and high video quality (e.g., 4K or 1080p quality). Managing these concurrent live streams at scale can require complex load balancing and interfacing with the client applications, which can lead to performance degradation, latency spikes, and dropped connections.

Many of these solutions also often lack seamless integration between gameplay, live spectating, and social interactions. For example, some online digital games, such as online gaming tournaments, include multiple players competing in structured bracket rounds until a winner is ultimately determined. Some client applications lack the ability for spectators to easily navigate through an ongoing tournament, select a specific match, and watch it unfold in real-time. This can lead to fragmented experience for spectators who wish to follow multiple live online matches in the same tournament, follow separate matches from multiple tournaments at the same time, and analyze scores and gameplay in multiple matches. This limitation can also hinder spectators from fulling engaging in social interactions centered around the online digital game. Many of these social interactions, such as live chatting, betting and wagering, voting on players, and other forms of engagement, often require a seamless, real-time viewing experience to be effective.

Another challenge is the absence of a centralized solution with visibility into the online tournament. For example, some digital competitive matches may be streamed without notice, leading to lower spectator engagement, missed opportunities to attract a wider spectating audience, and decreased viewership. Further, these applications can lack the ability to provide real-time scores, highlights of the online match, or detailed analytics. This can create an uninteresting spectator experience. As such, there is a need for a centralized approach to enable spectators to view and interact with a live digital game being played by players in real-time.

Accordingly, some implementations of the current subject matter include an approach to integrate a seamless digital content experience for both players and spectators. For example, the approach described herein can provide approximately real-time data streams from a vast number of client devices (e.g., client devices ranging with varying capabilities, operating systems, and functionalities) associated with a similarly vast number of users (e.g., players) to an equally large number of viewer client devices (e.g., spectators). In particular, the system describe herein can control the operation of multiple cloud-based applications running on player and spectator client devices to facilitate a live stream of digital content in an integrated and computationally efficient manner.

For example, this approach can receive data characterizing live streams of digital content representing content instances from multiple client devices (e.g., players participating in the event). The content instances can include distinct perspectives or versions of the same digital content. For example, the content instances can include gameplay views from two player's perspectives, multiple video feeds capturing different angles of a live event, or different aspects from a real-time event. The live stream data from these content instances can be captured by a cloud-based application running on the client devices (player's applications). The cloud-based applications can interface and exchange data directly with a centralized network. By capturing live stream data from the content instances using the player's applications, this approach can seamlessly transmit the live stream data to the network without computational overhead or reliance on a third-party software program. For example, the network server can include a load balancer to interface with the player's applications to dynamically balance the network load and resource allocation in the network. In some instances, this approach can provide capabilities that were not previously possible, such as providing spectators with real-time live streams from both player perspectives in a centralized location.

Additionally, the network can generate a content event (such as a scheduled event, online digital tournament, gaming session, a bracketed match, or other event-based matches) based on a common gameplay session between players. For example, given a scheduled match between two players, the player's applications can allow the players to schedule the content event (e.g., live digital competitive event) beforehand. The content event can be displayed to spectators, giving them notice of the scheduled event. This can attract a larger audience to the scheduled event.

Further, this approach can allow spectators to view, select, and interact with the content event in real-time. By using an instance of the cloud-based application running on spectator's client devices (e.g., spectator's application), the network can facilitate the live stream of digital content to multiple spectator applications. For example, the network can include a livestream service (LSS) that can efficiently direct the spectator's application to the correct streaming engine that is hosting the live stream event. Spectators can watch the live stream event on the spectator's application, such as concurrent livestreams from each player's perspective during a competitive match.

Additionally, the centralized network can provide supplemental data about the gameplay session. For example, the network can directly interface with the player's applications to relay detailed statistics to spectators, such as game scores, player performance, in-game events, and other contextual information that are not directly observable from the live stream alone. This additional information can provide spectators with insights that enhance their understanding of the event, enabling them to analyze gameplay strategies, track key moments, or predict potential outcomes.

Further, some implementations of the subject matter can require spectators to provide a request and identifier to access specific live stream content. This enables the network to control or restrict access to the live stream content. For example, the network can validate the identifier to limit only validated participants (e.g., paying subscribers, ticketholders, etc.) to the live stream content. As another example, the network can enable content-specific restrictions to certain events.

Some implementations of the subject matter can provide a holistic overview of the entire tournament. For example, the spectator's application can display a bracket view of the entire tournament which can include multiple ongoing content events (e.g., matches). In some implementations, the bracket view can provide a summary of each ongoing match and whether the match is currently live. In some implementations, the summary can include a real-time score associated with each content events. In some implementations, the bracket view can automatically rotate through each content event and display highlights, current progress, and/or data associated with each content event. This allows spectators to quickly determine which matches are live and determine an updated score of each individual match in real-time. The spectator's application can allow spectators to watch the entire tournament from a holistic view or select a livestream match between specific players and engage with the content in real-time.

In some implementations, the live stream of digital content can be partitioned into a plurality of segments corresponding to a predefined timeframe. The network can delete the plurality of segments from memory after the live stream of digital content has concluded. This reduces the computational overhead and memory constraints on the system. In some implementations, the network can determine variations in the content event according to a score threshold. For example, the score threshold can be associated with a critical game event or turning point in the match. The score threshold can correspond to one or more of the plurality of segments. As such, these segments can be displayed to the spectators, providing highlights and key moments of the content event.

The present invention is directed to systems and methods for interacting with multiple cloud-based applications to facilitate the coordination of live stream events across multiple client devices. For example, the present invention can facilitate live stream events between a first cloud-based application running on a first player's client device, a second cloud-based application running on a second player's client device, and a third cloud-based application running on a spectator's client device. The first player client device and the second player client device can participate in a content event, such as an online competitive match. The competitive match can be part of a larger tournament, such as an online gaming tournament.

Live stream data captured on the first and second cloud-based applications (e.g. player's applications), such as video, audio, and gameplay data, can be streamed in real-time to a centralized network. Spectators can interact with the network using a third cloud-based application (e.g., spectator's application) to view data associated with the event. Spectators can receive the live stream data by running the spectator's application on a local browser or natively on the spectator's client device.

The spectator's application can include a graphical user interface (GUI) to display various viewpoints of the live stream event and tournament. For example, the GUI can show a content page displaying a live stream video from both the first and second player's applications in real-time. The GUI can also display a holistic view of an entire tournament event, including scores and highlights across the entire tournament. Spectators can interact with the GUI to socialize and chat with other spectators or to view the live stream or highlights corresponding to a specific match.

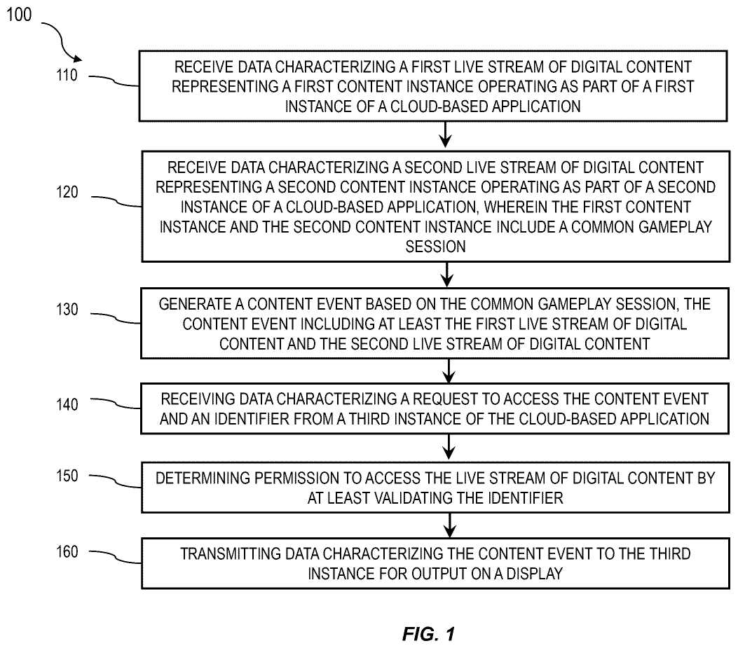

FIG. 1 is a process flow diagram illustrating an example method 100 for coordinating live stream events across multiple client devices. FIG. 1 describes an approach to controlling the operation of multiple cloud-based applications, such as a first cloud-based application running on a first player client device, a second cloud-based application running on a second player client device, and a third cloud-based application running on a spectator client device. The approach can facilitate live stream events from the player client devices to the spectator client devices.

At 110, data can be received characterizing a live stream of digital content representing a first content instance operating as part of a first instance of a cloud-based application. The received data can include video data, audio data, and metadata associated with a live event. For instance, given a multiplayer online gaming tournament, the data can include real-time gameplay footage from a player's perspective, in-game audio, player commentary, user interface overlays, and/or system-generated data such as gameplay statistics, health indicators, or points. In some implementations, the data can include a live feed from an event, such as a live sporting event, live concert, or similar live events. In some implementations, the data can include information associated with the event, such as highlights, key scoring moments, outcomes, score updates, projections, etc.

The data can be received using different transmission protocols, such as Hypertext Transfer Protocol Live Streaming (HLS), Real-Time Messaging Protocol (RTMP), or similar communication protocols. However, other suitable server communication protocols, encoding techniques, and/or transmission protocols for video/audio media data are possible.

The first content instance can include a first perspective of a digital experience. For example, the first content instance can include a player's perspective of a digital game instance, a player's inputs and decisions in a competitive match, or one perspective in a multiplayer event. In some implementations, the first content instance can include a perspective from an interactive media session or live event, such as a specific view from a live concert performance or sporting event.

The first content instance can operate in various configurations as part of the cloud-based application on the first client device (e.g., player's application). The player's application can interface with any type of client device (e.g., smartphones, tablets, laptops, desktop computers, gaming consoles, and the like) running any type of operating system and independent of the underlying hardware and device characteristics of the client device. The player's application can be configured to format the live stream data into one or more of the transmission protocols to be received by the network.

In some implementations the first content instance is configured to operate independently of the player's application. For example, the first client device can run a client application, such as a video game, natively on the device. The cloud-based application can function primarily as a streaming application running on the client device that captures the display and audio outputs of the client application. The cloud-based application can transmit the corresponding video and audio data as the live stream data to the network. In such cases, the cloud-based application can be configured as a lightweight and computationally simple application that requires minimal processing power. Conversely, the data management, processing, and distribution can be completed by the network. For example, the cloud-based applications on the client devices can process and transmit the live stream of digital content, such as video and audio streams, while the network can handle the transcoding, load balancing, and content distribution to spectators. This can reduce the computational load and processing requirements on the client devices.

In some implementations, the first content instance is integrated into the cloud-based application. For example, the player's application can host gameplay sessions directly within the application environment, such that the gameplay logic, rendering, and data processing are executed by the application. The player's application can record the player's inputs, such as movements, attacks, and commands, and transmit this data to the network.

In some implementations, the player's application is configured as a browser-based cloud application. For example, the player's application can be integrated into a third-party application, web sites, or web browser. Players can interact with the digital content in an internet browser without requiring any local installations. The digital content can be streamed from the network using a peer-to-peer connection, such as Web Real-time Communication (WebRTC) or similar approaches. For instance, a web-based tournament platform can allow players to initiate an online game through a browser-based player's application on their devices. This can allow users to execute their digital game instances (e.g., first content instance) across multiple platforms, provided they have an internet connection and supported web browser. In some implementations, the third-party applications and websites can offer different features and functionality via the integrated player's application that complement and enhance interaction and engagement with the third-party applications and websites.

In some implementations, the player's application can be rendered remotely and controlled by the network. For example, the entire content experience can be rendered and processed on the network. The client device receives compressed video and audio streams from the network without performing the intensive computations locally. The player's application can capture elementary data, such as the player's inputs or movements. This can help provide consistent performance and gameplay experience across multiple client devices.

At 120, data can be received characterizing a live stream of digital content representing a second content instance operating as part of a second instance of the cloud-based application. The second content instance and the second instance of the cloud-based application can operate similarly to the first content instance and the first instance of the cloud-based application. For example, the second content instance can include a second perspective (e.g., a second player's perspective) of the digital experience.

The first content instance and the second content instance can include a common gameplay session. For example, the first content instance and the second content instance can represent two separate digital experiences that are tied to the same underlying experience. For example, the first live stream of digital content can include gameplay data, video/audio feed, and/or control inputs for a first player while the second content instance can include similar gameplay data, video/audio feed, and/or control inputs for a second player. In some implementations, the first content instance and second content instance can include two digital game perspectives competing against one another in an online event or tournament. For example, the first content instance and second content instance can include two digital game perspectives in an online chess match (e.g., black and white) or a head-to-head match in a mobile game. The first content instance and second content instance can also include two digital game perspectives from two players working together in the same game or the same game instance, such as two players competing in the same Tetris seed or a co-operative digital game. In some implementations, the first content instance and second content instance include perspectives from a larger cohort, such as a team's perspective or an organization's perspective.

In some implementations, each content instance can be configured to include player-specific data, such as unique camera angles, UI configurations, or control schemes. For example, the first content instance and the second content instance can represent different aspects of a common gameplay session. For example, given a player livestreaming a single-player game, the first content instance can correspond to a visual feed of the video and audio from the game, while the second content instance can correspond to the player's tactile inputs, such as keyboard, mouse, or controller inputs, corresponding to the game. As another example, the first content instance can correspond to one point-of-view from the event, such as a panoramic view or an overhead view, while the second content instance can correspond to another point-of view, such as a close-up video feed of the player or a live audience feed.

At 130, a content event can be generated based on the common gameplay session. The content event can include at least the first live stream of digital content and the second live stream of digital content. For example, the network can be configured to generate an organized event based on the match. The content event can include various types of organized gameplay events, such as a scheduled competition, an online digital tournament, a gaming round, or a designated match within a broader gaming tournament.

In some implementations, the content event can be generated asynchronously. For example, the content event can be generated by periodically polling and analyzing data from the gameplay session and the player's applications. For example, the content event can be scheduled in advanced by analyzing when players register for a designated match in a competitive game. In some implementations, players can register for a designated match using the player's application. For example, the player's application can display a designated digital content page that enables players to sign up for the content event beforehand. In some implementations, the player's application can notify the player's client device when the content even is about to begin.

In some implementations, the content event can be generated automatically when the system detects multiple client devices running the same gameplay session. For example, if the network detects two or more cloud-based applications running the same competitive match, the network can begin the content event automatically and begin receiving live stream data from both instances.

In some implementations, once the content event is generated, a live chat functionality can be enabled to allow the players to chat and socialize with one another. For example, the player's application can send a request to the network to create a chat room specific to the content event. All players who register for the content event can access the chat room and socialize with other players in the content event. The chat room can be connected to auto-moderation features. For example, the chat can be checked against a list of banned words specific to the content event. Players who use the banned words can be automatically blocked from chatting further for a configurable period.

At 140, data can be received that characterizes a request to access the live stream content and an identifier from a third instance of the cloud-based application. For example, the third instance of the cloud-based application can run on a spectator's client device (e.g., spectator's application). The spectator's application can include spectator-focused functionality, such as an interface for spectators to view and interact with the content event.

For example, the spectator's application can include a graphical user interface (GUI) that displays a list of available content events. The GUI can display the content events associated with a tournament or online gaming event in several formats, including bracketed or tiered events, structured head-to-head matches, predicted winners, or other similar formats. The GUI can also include links or selectable options to allow spectators to join a desired content event. The GUI can further provide real-time updates on active content events, such as indicating which gameplay sessions are in-progress, displaying current scores, and/or highlighting key moments from ongoing matches. In some implementations, the spectator's application can include features that allow spectators to filter or sort content events based on criteria such as game type, player rankings, tournament progression. Additionally, the spectator's application can include interactive elements that enable spectators to access data about the content event, such as live statistics, player profiles, betting predictions, or strategic insights. In some implementations, the GUI can include a list of active tournaments, each with one or more content events. The spectator can select which active tournament and which content event to spectate. While spectating a content event, the network can send the corresponding live stream data to the spectator's application.

The spectator's application can receive live stream data while the network handles the content distribution. For example, the spectator's application can receive compressed data from the network, such as video and audio data or gameplay metrics, decompress the data, and render it locally. In some implementations, the spectator's application can operate within a web browser. This can allow spectators to access the live stream of digital content across multiple platforms without requiring additional software or third-party applications running on the spectator's client device.

To access the content event, the spectator's application can send a request and an identifier to the network. For example, once the spectator has selected a specific content event, the spectator's application can request access to the live stream of digital content from the network and provide an identifier for authentication. In some implementations, the request to access the content event and the identifier can be sent automatically, such as when the spectator opens or logs into the spectator's application. The request can include metadata such as an identification of the specific content event, device capabilities, network conditions, or viewing preferences to ensure the live stream is delivered in an optimized format.

The identifier can include information necessary to access the content event. For example, the identifier can include information pertaining to the spectator or the spectator's client device, such as the spectator's credentials, session identification (ID) token, tournament match reference, stream URL, authentication token, etc. The identifier can also include a unique reference to the specific live stream or game session. In some implementations, the identifier can be generated before the spectator requests access to the content event, such as when the spectator logs into the spectator's application, pays to purchase the live stream event, or registers for the scheduled event. In some implementations, the identifier can be generated once the spectator requests access to the content event.

At 150, permission can be granted to the live stream of digital content by validating the identifier. The identifier can be received by the network and verified against a set of predefined access rules to access the specific content event. For example, if the identifier includes a specific session ID corresponding to a specific tournament match, the network can verify the match is currently active and direct the spectator to the match. As another example, the identifier can be compared to a list of authorized participants, spectators, or registered viewers.

Certain live streams can be designated as private in a scheduled gaming tournament. These restricted events can limit access to verified participants, such as coaches, designated spectators (e.g., paid or subscribed members), or spectators with elevated status. In such cases, the network can validate the identifier to confirm the spectator's client device corresponds with an approved viewer before granting access to the content event. Conversely, the identifier can be used enforce streaming limits or apply content-specific restrictions to certain content events.

In some implementations, the identifier can include an expiration timestamp or a session token to prevent unauthorized reuse of the credential after a designated time. Additionally, the identifier can correspond to a specific role-based access. For example, the different types of identifiers can correspond to varying levels of access, such as distinguishing between general spectators, commentators, moderators, and tournament administrators.

At 160, once permission to access the content event is granted, data characterizing the content event can be transmitted to the third instance for output on a display. For example, the spectator's client device can be coupled to a display, such as a monitor, television screen, public billboard, projector, or other screen elements. Data can be transmitted to the spectator's application for display on this screen, such as a live stream of the digital event. The data can be transmitted using live stream or video data protocols, such as Hypertext Transfer Protocol Live Streaming (HLS), Real-Time Messaging Protocol (RTMP), or other communication protocols. In some implementations, data from the first live stream and the second live stream can be displayed on the screen. For example, viewpoints from both player's perspectives from the same gameplay session can be displayed side-by-side. In some implementations, only data from one live stream can be displayed on the screen. In some implementations, data from a pre-recorded livestream or video can be displayed alongside a second live stream. For example, if two players are playing a head-to-head Tetris match at different times, the first player's pre-recorded live stream can be displayed with the second player's live gameplay at the same time.

In some implementations, the data transmitted to the spectator's application can include data associated with the content event, such as scores, highlights, predictions, or the like. For example, the spectator's application can display a bracket view of the entire tournament, including brackets and summaries of each individual event. The spectator's application can determine, in real-time, scores associated with each individual gaming event by exchanging data with the network. Once a score or highlight is updated in the content event, the network can transmit the score update to the spectator's application to be updated on the display. In some implementations, the system can continuously determine the score or other metrics and transmit the data continuously for the duration of the content event. For example, while a live sporting event is occurring, the network can continuously determine any score updates or highlights and transmit any updates to the third content instance for display. In some implementations, once the live stream has ended, the spectator's application can display a results screen and send a request asking for the results to the network. The network can provide the results of the match, which can be displayed on the spectator's application.

In some implementations, once the spectator enters the content event, a live chat functionality can be enabled to allow spectator to interact with other spectators and/or the players. Like the player's chat, the spectator chat can be connected to auto-moderation features.

In some implementations, the data characterizing the content event can be partitioned into a plurality of segments. For example, upon receiving a request to access the content event, the network can partition the live stream received from the first client device and/or the second client device into a plurality of segments. Each segment can correspond to a predetermined timeframe. For instance, each segment can include a timestamp correlating a specific instance or clip of the live stream media, such as a one-second clip or a one-minute clip.

Rather than storing the entire live stream in memory (which can take a considerable amount of memory), one or more of the plurality of segments can be stored in memory. For example, the segments can be stored locally in the network cache or database. The cache can provide low-latency access to recently identified segments to provide rapid delivery to spectators requesting key events. The database can maintain a more persistent storage solution and index and retrieve segments.

In some implementations, the plurality of segments are stored in memory once the request to access the content has been validated. In such cases, memory overhead can be reduced because segments are only stored once the spectator is spectating the event, rather than storing the entire live stream in memory. In some implementations, segments corresponding to the entire live stream can be stored in memory. This can allow spectators to watch the live stream event from the beginning and rewind to find highlights or important portions of the content.

Once the segments are stored locally in memory, they can be transmitted to the third instance for output on the display. In some implementations, the one or more of the plurality of segments are deleted from memory after the event has concluded. In some implementations, the one or more of the plurality of segments can be deleted from memory after a period or after the spectator has logged off from the event. As such, the network can significantly reduce the amount of memory capacity required and the computational overhead required to receive and distribute the live stream data to multiple client devices.

In some implementations, the live stream of digital content can be partitioned into a plurality of segments based on a determination that a variation in a score satisfies a predefine threshold. For example, the network can monitor changes in the score during the content event and identify moments when the score fluctuates significantly, such as a lead change, a sudden comeback, or pivotal scoring event. Upon detecting such variations that meet or exceeds the threshold, the one or more segments corresponding to that moment can be identified and stored locally on the network. Then, the identified segments can be automatically identified and displayed on the spectator's application to showcase key moments in the content event.

In some instances, the segments can be presented as clickable thumbnails, timeline markers, or entries in a highlight reel. These can allow spectators to quickly access impactful moments from the content event. Additionally, these highlights can be automatically displayed on the spectator's application, such as a public billboard or display, and automatically show highlights from a content event. In some implementations, additional metadata such as timestamps, score details, gameplay inputs, or other metrics can be included to provide context for each segment.

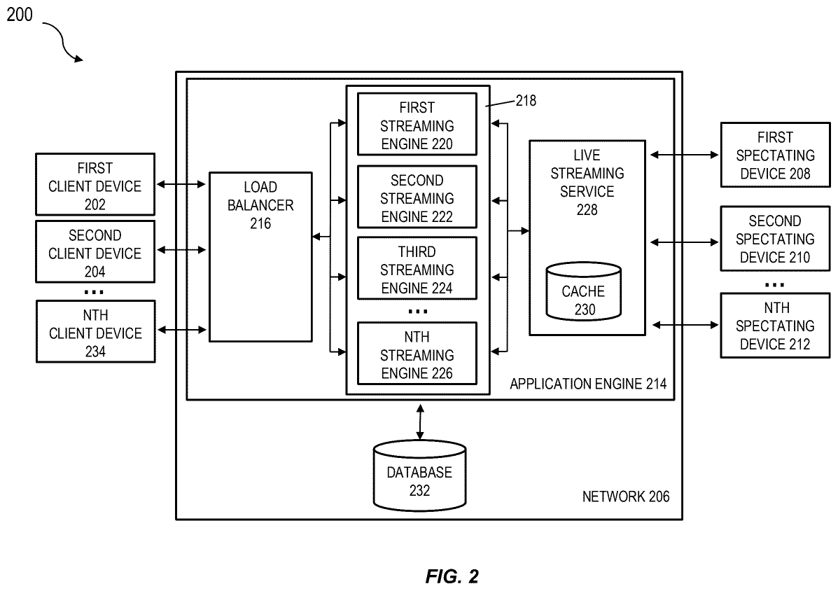

FIG. 2 illustrates an example embodiment of a system that can coordinating content events across multiple client devices. The system 200 can include a first client device 202, a second client device 204, an Nth client device 234, a network 206, a first spectating device 208, a second spectating device 210, and an Nth spectating device 212. The network 206 can further include an application engine 214 and a database 232. The application engine 214 can include a load balancer 216, a plurality of streaming engines 218, and a live streaming service 228. The plurality of streaming engines 218 can include a first streaming engine 220, a second streaming engine 222, a third streaming engine 224, and a Nth streaming engine 226. The live streaming service 228 can include a cache 230.

The first client device 202 can send data characterizing the first live stream of digital content to the network 206. The first client device can include an electronic device, such as a mobile phone, PC, network system, or other computing devices. The first client device 202 can also include a local storage, remote server, database, or software service designed to send data to the network 206. The first client device 202 can also include other devices found in computerized or live stream environments. The first client device 202 can be operatively coupled or configured to communicate with the network 206. In some implementations, the first client device 202 can comprise multiple client devices, such as multiple mobile phones, multiple network servers, etc.

In some implementations, the second client device 204 is substantially the same as the first client device 202. In some implementations, the first client device 202 can comprise one computing device, such as a mobile phone, while the second client device 204 can comprise a different computing device, such as a PC. In some implementations, the system 200 includes additional client devices, such as a third client device up to an Nth client device 234, where N can be any suitable number and can vary over time.

The player's applications running on the first client device 202, second client device 204, and Nth client device 234 can send data characterizing the live streams of digital content to the network 206. For example, the player's applications can send the data using a transmission protocol, such as HLS, RTMP, or similar communication protocols.

The data can be received by the network 206. The network 206 can include a cloud-based network (e.g., Amazon Web Services, Google Cloud, Microsoft Azure, or other suitable cloud-based infrastructure provider) or include dedicated server hardware. The network 206 can include an application engine 214 and a database 232.

The application engine 214 can include the load balancer 216, the plurality of streaming engines 218, and the live streaming service (LSS) 228. The application engine 214 can manage the coordination and allocation of the plurality of streaming engines 218. For example, the application engine 214 can allow for registration/deregistration of streaming engines, atomic reservation of streaming engines, querying of streaming engines, and the like. The application engine 214 can maintain any suitable number of streaming engines in the plurality of streaming engines 218 and register (i.e., instantiate, allocate, or otherwise create) or deregister (i.e., delete or deallocate) streaming engines as necessary. In some implementations, the network 206 can include a plurality of application engines 214, each with a plurality of streaming engines 218 to manage the incoming live stream data.

The load balancer 216 can receive the data from the plurality of client devices (e.g., client devices 202, 204, and 234). The load balancer 216 can manage the distribution of incoming data from the client devices. For example, the load balancer 216 can monitor various parameters such as the bandwidth of network 206, processing load, memory usage, and active connections associated with the plurality of client devices. Based on these metrics, the load balancer 216 can allocate and distribute the incoming live stream data from the client devices to one or more of the various streaming engines in the plurality of streaming engines 218. By dynamically managing the traffic flow and balancing the distribution of the live stream data, the load balancer 216 can help mitigate network congestion and provide consistent delivery of live streaming content with minimal buffering or interruptions.

In some implementations, the load balancer 216 can reserve an appropriate streaming engine 220-226, load or cause to load the streaming engine 220-226 with the requested live stream data, and bind or otherwise link the reserved streaming engine 220-226 to an active session. If no streaming engine 220-226 is available for the active session, the load balancer 216 can instruct the application engine 214 to add and register a new streaming engine for the requested active session.

In some implementations, the load balancer 216 can include a transport layer or application layer to intelligently distribute the incoming data to the plurality of streaming engines 218. For example, the load balancer 216 can allocate data to the plurality of streaming engines 218 based on internet protocol (IP) address, geographical location, or transmission control protocol (TCP) and user datagram protocol (UCP) port numbers. In some implementations, the load balancer 216 can allocate data to the plurality of streaming engines 218 based on the type of client device and/or the instance of the cloud-based application. For example, if the first client device 202 is a mobile device while the second client device 204 is a PC, the load balancer 216 can route all mobile device traffic to the first streaming engine 220 while all PC traffic is routed to the second streaming engine 222. As another example, if the first client device 202 is running the cloud-based application natively on the system while the second client device 204 is running the cloud-based application in a web browser, the load balancer 216 can route the corresponding network traffic to the first streaming engine 220 and the second streaming engine 222 respectively.

One or more streaming engines (e.g. streaming engines 220-226) from the plurality of streaming engines 218 can be configured to receive the live stream data from the load balancer 216. The plurality of streaming engines 218 can include any number of streaming engines to support an appropriate type of live streaming service. For example, the plurality of streaming engines 218 can include a first streaming engine 220, a second streaming engine 222, a third streaming engine 224 . . . and an Nth streaming engine 226, where N can be any suitable number and can vary over time.

The plurality of streaming engines can be configured to facilitate the encoding, transcoding, and distribution of the live stream content. For example, each streaming engine 220-226 can include a video/audio module for managing and storing video and/or audio media data received from the load balancer 216. For example, the video/audio module can perform real-time encoding to compress the incoming live stream data into one or more streaming formats suitable for transmission over the network 206. The video/audio module can encode the data using codecs such as H.264, H.265, or VP9 to achieve optimal video quality with reduced bandwidth. Additionally, the video/audio module can support communication protocols such as HLS, RTMP, or similar communication protocols. However, other suitable server communication protocols, encoding techniques, and/or transmission protocols for video/audio media data are possible.

The video/audio module can also perform transcoding operations to generate multiple output streams from the original live stream data. For example, the video/audio module can generate streams at different resolutions, bitrates, or formats to accommodate spectator client devices with varying capabilities or network constraints. For example, a high-definition (HD) stream can be provided to spectators with a high-bandwidth connection, while a lower standard-definition (SD) stream can be offered to devices with limited bandwidth and/or processing power.

Each streaming engine 220-226 can also include a state module for receiving and processing input (e.g., mapping input to the video/audio stream, etc.) from each client device. For example, the state module can maintain the state of the cloud-based application running on each client device (e.g., whether the client device is live streaming or off, what data is being transmitted, etc.).

In some implementations, the data stored in or otherwise used by each streaming engine 220-226 can be ephemeral. For example, the corresponding streaming engine from 220-226 can be deregistered at the end of an active session. Accordingly, all data stored or otherwise used by the streaming engine during that active session can be deleted, for example, no later than the deregistration of the streaming engine. In some implementations, the data stored in or otherwise used by corresponding streaming engine from 220-226 during the active session can be stored (e.g., in database 232) retrieved, and used in and with a subsequent active session by the spectators. Once the spectating engine has been deregistered, it can be reused for another active session or its computing resources can be reallocated to a different content event.

The live streaming service (LSS) 288 can manage the flow of data between players who are live streaming data and spectators who wish to spectate the live streams. The LSS 288 can track and cache which streaming engine includes the live stream data. The LSS 228 can also allow spectators who wish to spectate the live stream event to query for that specific streaming engine. The LSS 288 can also track the number of spectators per live stream event.

The LSS 228 can register and record a corresponding live stream event into memory. For example, the LSS 228 can receive an identifier (e.g., a POST request) from one or more of the streaming engines 220-226. The POST request can include identifiers, such as TP.ID and a PODLP. The POST request can include a command to create or update a resource. For example, once a live stream event has started, the POST request can include a unique identifier for that event and be sent to the live streaming service 228 to be stored in the cache 230 or database 232. The TP.ID and PODLP can be retrieved from the cache 230 and/or database 232 by the LSS 228 when a spectating device attempts to connect to the corresponding live stream event.

The LSS 228 can be configured to receive data from one or more streaming engines 218 and facilitate the coordination and distribution of live stream content to the various spectating devices 208-212. For example, the live streaming service 228 can receive a request to access a live stream event and identifier from one of the spectating devices 208-212. The request can include metadata such as device capabilities, network conditions, or viewing preferences to ensure the live stream is delivered in an optimized format.

The identifier can include information necessary to access the content event. Once the LSS 228 receives the identifier, the LSS 228 can validate the identifier to confirm the live stream exists and the spectator is authorized to access the requested live stream. For example, the LSS 288 can verify an authentication token against a list of authorized client devices, participants, or registered viewers stored in the cache 230 or database 232. In some implementations, the LSS 288 can use the authentication token to check whether the TP.ID exists in the cache 230 or database 232 and verify whether the live stream event is currently live.

Upon verifying the identifier, the LSS 228 can establish a connection between the spectating device and the corresponding streaming engine 218. In some implementations, the LSS 288 facilitates this connection by establishing a session between the spectating device and the corresponding streaming engine 218 using a uniform resource locator (URL), IP address with port details, or other connection parameters depending on the streaming protocol. In some implementations, the LSS 288 can maintain the session to manage reconnections, time-limit permissions, or coordinate load balancing if resources are constrained.

Once the identifier is verified, the corresponding streaming engine from the plurality of streaming engines 218 can send the live stream data to the spectating client device. For example, system 200 can include a first spectating device 208, a second spectating device 210 . . . up to an Nth spectating device 212, where N can be any suitable number and can vary over time. The spectating devices 208, 210, and 212 can be substantially similar to the first client device 202 and the second client device 204. For example, the spectating devices 208, 210, and 212 can include an electronic device, such as a mobile phone, personal computer (PC), network system, or other computing devices. In some implementations, the spectating devices 208, 210, and 212 can include electronic devices found in live stream environments, such as a public billboard or large-screen projector.

The database 232 can store information pertaining to the live stream events. For example, the database 232 can securely store, retrieve, and manage identifiers (e.g., TP.ID and POSTLP) corresponding to each live stream event. The database can also include access lists that identify approved spectator client devices for each content event. The database can include any suitable type of database, such as a relational database (e.g., Oracle database, IBM DB4, Microsoft SQL Server, MySQL, and PostgreSQL), a non-relational database (e.g., Neo4j, Redis, Apache Cassandra, Couchbase Server), a network database, a hierarchical database, an object-oriented database, a proprietary form of database, and various combinations and configurations of the foregoing.

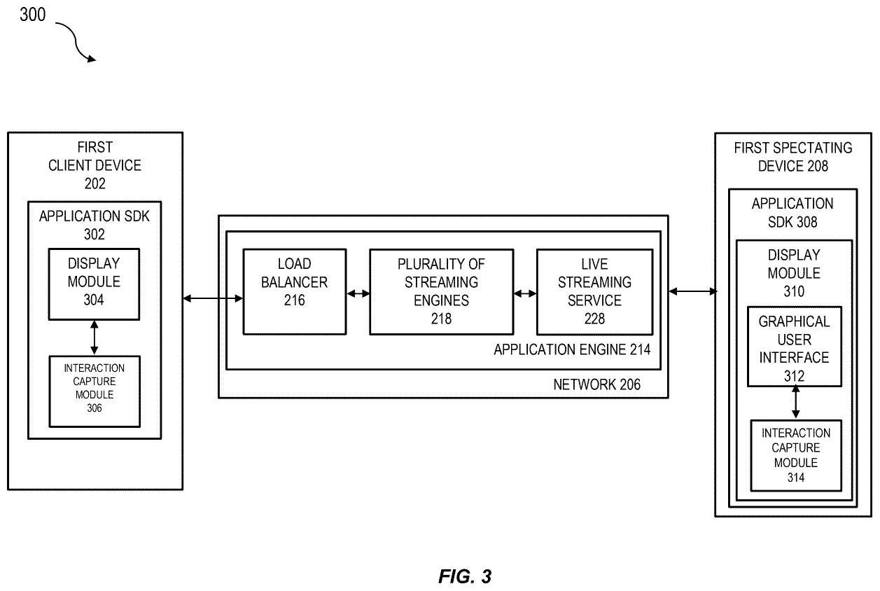

FIG. 3 illustrates aspects of the system from FIG. 2. For example, the first client device 202 can include an application software development kit (SDK) 302. The application SDK 302 can include a display module 304 coupled to an interaction capture module 306. While FIG. 3 illustrates aspects of the first client device 202, the second client device 204 and the Nth client device 234 can be substantially similar.

The application SDK 302 can host the first instance of the cloud-based application and the first content instance. For example, the application SDK 302 can run the first content instance (e.g. online digital game) natively on the first client device 202. Using the application SDK 302, the cloud-based application can capture data from the digital game and transmit the data to the network 206.

In some implementations, the application SDK 302 is a browser module that runs the cloud-based application and the content instance within the application SDK 302 environment. The browser module can be a suitable application capable of supporting the local rendering of the video/audio information streamed from the client device to the cloud-based client applications (e.g., via OpenGL or the like). The browser module can support any suitable type of browser application, such as, for example, Google Chrome, Mozilla Firefox, Microsoft Edge, Apple Safari, DuckDuckGo, Opera, Brave, Vivaldi, Firefox Focus, a proprietary browser, or the like.

In some implementations, the application SDK 302 can include a display module 304 and an interaction capture module 306. The display module 304 can capture video and/or audio information from the first client device 202. In some implementations, the display module 304 can capture video and/or audio data from the client application running natively on the first client device 202. In some implementations, the display module 304 can screen capture the first client device 202 and provide video and audio data that is outputted from the first client device 202.

In some implementations, the user's inputs can be collected by the interaction capture module 154 and communicated to the network 206. The user's inputs can then be mapped to the video/audio stream by the plurality of streaming engines 218 to allow the user to (remotely) control and interact with the cloud-based client application in real-time as if the cloud-based client application was running natively on the first client device 202.

The first spectating device 208 can include an application SDK 308. The application SDK 308 can include a display module 310 running a graphical user interface (GUI) 314. The display module 310 can also include an interaction capture module 314. A spectator can interact with the spectator's application running in the Application SDK 308. For example, the spectator's application can interface with the graphical user interface 312 to select and watch their selected live stream content. While FIG. 3 illustrates aspects of the first spectating device 208, the second spectating device 210 and the Nth spectating device 212 can be substantially similar.

In some implementations, the video/audio output of the live stream event running in the one or more of the streaming engines 220-226 can be streamed in real-time via the Internet (or other suitable network) to the application SDK 308 of the first spectating device 208 and displayed using the display module 310. The display module 310 can receive the streamed video/audio output from the streaming engines 220-226 and render it appropriately on a display screen of the first spectating device 208.

Spectators can interact with the video/audio stream of the spectator's application in real-time using the graphical user interface 312. For example, spectators can use the graphical user interface 312 to input messages into a live chat associated with the live stream content or adjust settings such as the resolution and size of the content on the display. In some implementations, the user's inputs can be collected by the interaction capture module 314 and communicated (over the internet or other suitable network) to the live streaming service 228. The spectator's inputs can be mapped to allow spectator to control and interact with the live stream content.

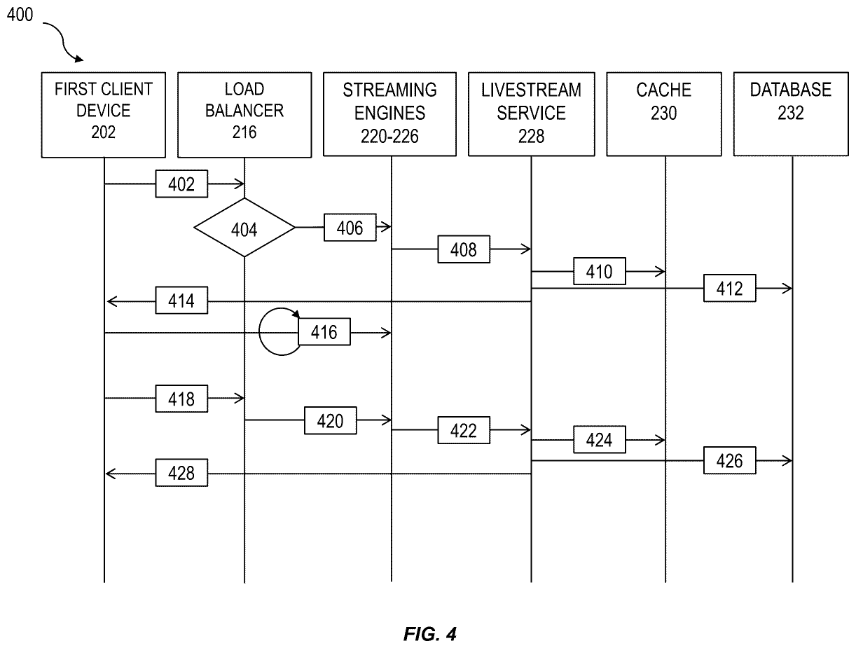

FIG. 4 is a data flow diagram illustrating an example embodiment of data exchanged between the first client device 202 and the network 206 during a live stream event. At 402, the instance of the cloud-based application running on the first client device 202 can send live stream data to the load balancer 216. The live stream data can include video data, audio data, and metadata associated with the live stream event.

At 404, the load balancer 216 can manage the distribution of incoming data from the first client device 202. For example, the load balancer 216 can monitor various parameters to determine how to allocate and distribute the incoming data to one or more of the streaming engines 220-226. At 406, the live stream data can be sent to one or more of the allocated streaming engines 220-226.

Once the live stream data is allocated and sent to one or more of the streaming engines 220-226, an identifier can be sent to the live streaming service 228 to register and record the corresponding streaming engine. For example, if the live stream event is allocated to the first streaming engine 220, a POST request can be sent to the LSS 228 (including a TP.ID and PODLP) to record the live stream event. The LSS 228 can analyze and store the identifier. For example, at 410, the LSS 228 can store the identifier in the cache 230. At 412, the LSS 228 can store the identifier in the database 232.

At 414, a confirmation signal can be sent back to the first client device 202. For example, once the live stream event is confirmed to be allocated to one or more streaming engines 220-226 and the identifier is stored in cache 230 or the database 232, a signal indicating that user is successfully livestreaming can be sent and displayed on the first client device 202. If the live stream event is not successfully allocated, the signal 414 can include a message, such as a message to restart the live stream event or attempt the live stream at a later time. At 416, live stream data can be continuously sent from the first client device 202 to the one or more allocated streaming engines 220-226. In some implementations, this data can be saved as one or more plurality of segments.

At 418, once the live stream event has concluded, the first client device 202 can sent a request to the load balancer 216 to end the live stream session. The request can include identifying information, such as the session ID, stream ID, or a stream-specific identifier. At 420, the request can be sent to the corresponding one or more streaming engines 220-226 to end the live stream event. For example, the streaming engines 220-226 can release any allocated resources and return an available status for subsequent live stream events. At 422, the request can be sent to the LSS 228, which can clear the cache 230 of the TP.ID and PODLP at 424 and clear the database 233 of the TP.ID and PODLP at 426. At 428, a confirmation message can be sent from the LSS 228 to the first client device 202 that the live stream event has concluded.

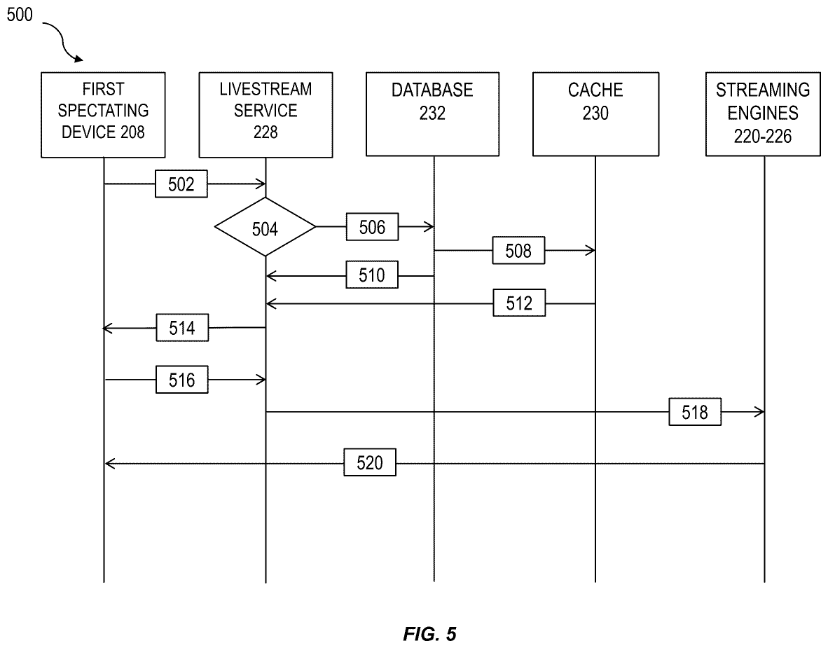

FIG. 5 is a data flow diagram illustrating an example embodiment of data exchanged between the first spectating device 208 and the network 206 during a live stream event. For example, at 502, the first spectating device 208 can send data characterizing a request to access a live stream event and an identifier to the LSS 228. In some implementations, the request can include a plain text request to access a specific livestream by username. At 504, the LSS 288 can validate the identifier to confirm the live stream exists and the spectator is authorized to access the requested live stream. In some implementations, the LSS 288 can convert the username to a userid associated with a TP.ID or a PODLP.

Upon verifying the identifier, the LSS 228 can establish a connection between the first spectating device 208 and the corresponding streaming engine from one or more of the streaming engines 220-226. In some implementations, the LSS 288 can identify the corresponding streaming engine 220-226 by locating the specific TP.ID and/or PODLP from memory. For example, at 506 the LSS 288 can determine the location of the corresponding streaming engine 220-226 by comparing the TP.ID and/or PODLP with those in cache 230. Similarly, the LSS 288 can compare the TP.ID and/or PODLP with those stored in the database 232. At 510 and 512, the locations can be returned to the LSS 228 if applicable.

At 514, the LSS 228 can send a confirmation message to the first spectating device 208. The confirmation can include a 200 or 404 status code. For example, the 200 code can confirm that the requested resource (e.g, live stream event) was found among the streaming engines 220-226. Conversely, the 404 code can indicate that the requested resource was not found among the streaming engines 220-226.

At 516, once the confirmation message is received by the first spectating device 208, the first spectating device 208 can send a request to access the live stream to the LSS 228. Once the request is sent to the LSS 228, the LSS 228 can send a proxy request to the corresponding streaming engine among the streaming engines 220-226. At 520, the corresponding streaming engine from the streaming engines 218 can send the live stream data to the first spectating device 208.

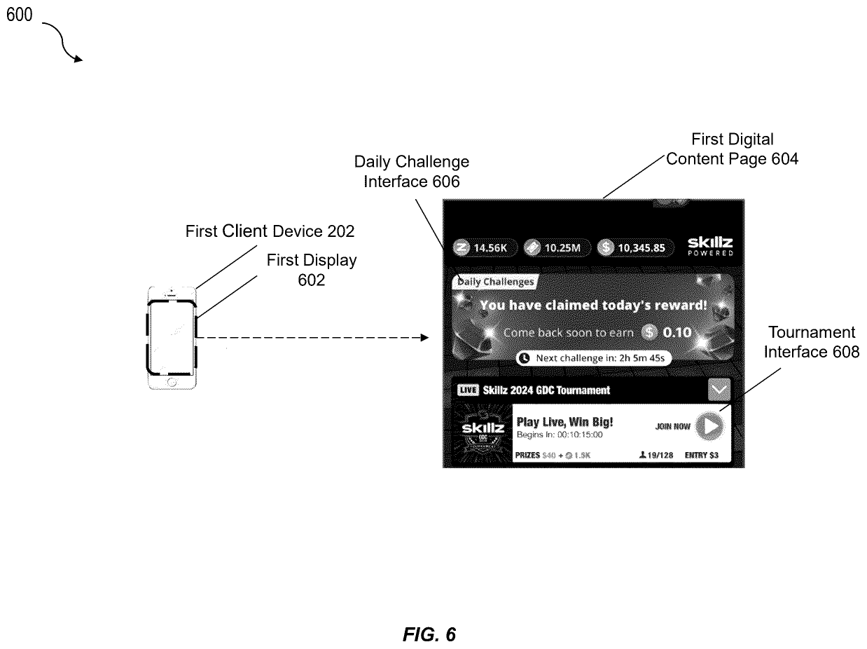

FIG. 6 is a diagram illustrating an example embodiment of system 600 including a first digital content page 604 outputted on a first display 602 of the first client device 202. For example, the system 600 can include a first client device 202, which includes a first display 602 such as a screen or external display. The first display 602 can include a first digital content page 604, which can include a daily challenge interface 606 and a tournament interface 608.

The first instance of the cloud-based application running on the first client device 202 can include the first digital content page 604. For example, the player's application can run natively on the first client device 202 and include several digital content pages, such as the first digital content page 604.

The user can interact with the first digital content page 604. For example, the user can complete daily challenges associated with an online gaming tournament by selecting the daily challenge interface 606. Further, the user can sign up to enter into a tournament beforehand. Once the tournament has started, the user can join the event by selecting the tournament interface 608. This will start the gameplay session against the other user. In some implementations, the user can select whether to start the live stream session during the start of the gameplay session.

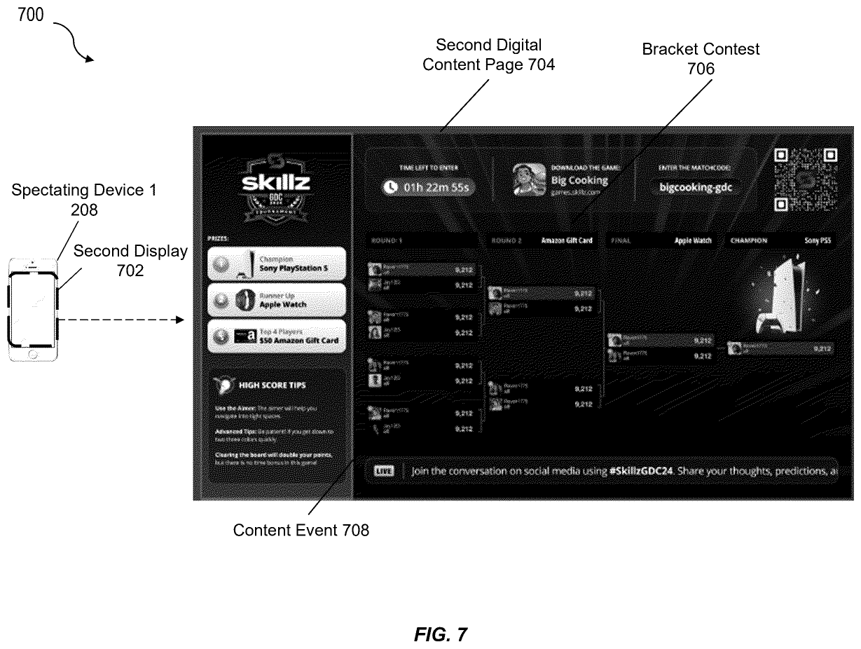

FIG. 7 is a diagram illustrating an example embodiment of system 700 including a second digital content page 704 outputted on a second display 702 of the first spectating device 208. For example, the system 700 can include the second client device 204, which includes a second display 702 such as a screen or external display. The second display 702 can include a second digital content page 704, which can include a bracket contest 706 and a contest event 708.

The spectator's application running on the first spectating device 208 can include the second digital content page 704. For example, the second digital content associated with various content events, such as content event 708.

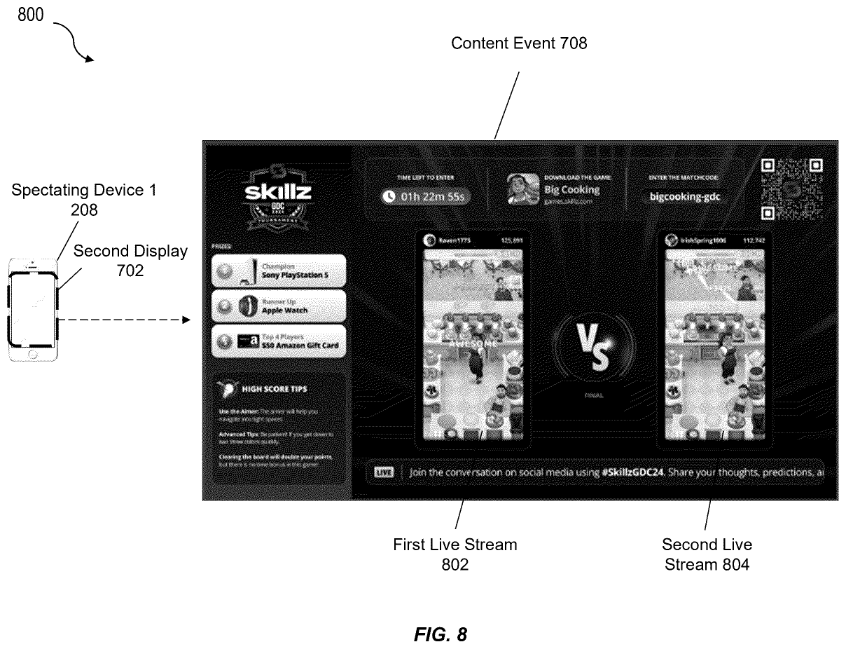

Spectators can view a live stream of the gameplay session by selecting the content event. For example, when a spectator selects the content event 708, the spectator's application can direct them to a live stream of the gameplay session. For example, FIG. 8 is a diagram illustrating an example embodiment of system 800 displaying the content event 708. The content event 708 can include a first live stream 802 displaying the perspective from a first player and a second live stream 804 displaying the perspective from a second player. Both players can compete in the same gameplay instance, allowing spectators to see both perspectives of players competing against one another.

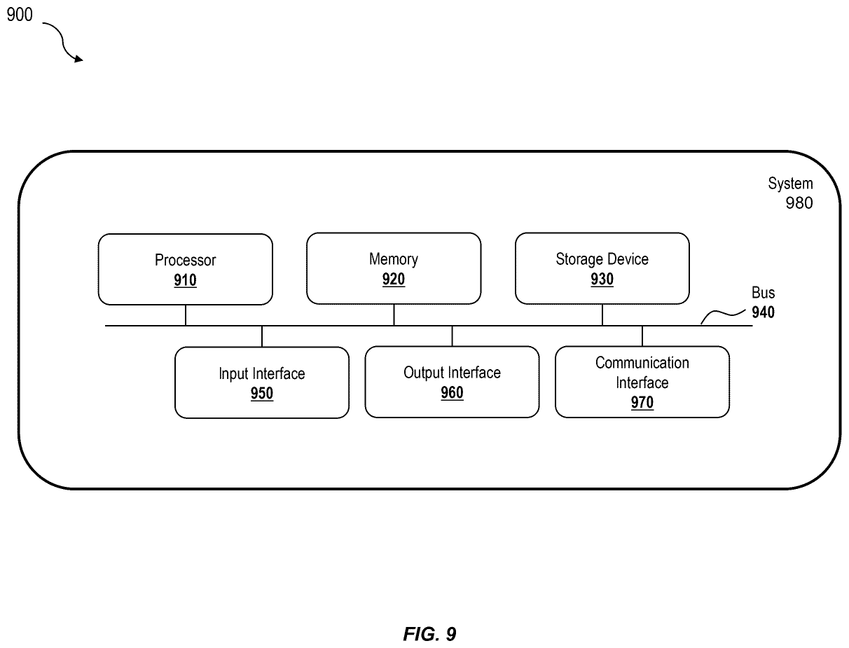

FIG. 9 is a system diagram illustrating one embodiment of a computing device configured in the system of FIG. 2. As illustrated, system 980 includes processor 910, memory 920, storage component 930, input interface 950, output interface 960, communication interface 970, and bus 940.

Bus 940 includes a component that permits communication among the components of system 980. In some implementations, processor 910 can be implemented in hardware, software, or a combination of hardware and software. In some examples, processor 910 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 920 includes random access memory (RAM), read-only memory (ROM), and/or another type of dynamic and/or static storage device (e.g., flash memory, magnetic memory, optical memory, and/or the like) that stores data and/or instructions for use by processor 910.

Storage component 930 stores data and/or software related to the operation and use of system 980. In some examples, storage component 930 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 950 includes a component that permits system 980 to receive information, such as via user input (e.g., a touchscreen display, a keyboard, a keypad, a mouse, a button, a switch, a microphone, a camera, and/or the like). Additionally or alternatively, in some implementations the input interface 950 includes a sensor that senses information (e.g., a global positioning system (GPS) receiver, an accelerometer, a gyroscope, an actuator, and/or the like). Output interface 960 includes a component that provides output information from system 980 (e.g., a display, a speaker, one or more light-emitting diodes (LEDs), and/or the like).

In some implementations, communication interface 970 includes a transceiver-like component (e.g., a transceiver, a separate receiver and transmitter, and/or the like) that permits system 980 to communicate with other devices via a wired connection, a wireless connection, or a combination of wired and wireless connections. In some examples, communication interface 970 permits system 980 to receive information from another system and/or provide information to another system. In some examples, communication interface 970 includes an Ethernet interface, an optical interface, a coaxial interface, an infrared interface, a radio frequency (RF) interface, a universal serial bus (USB) interface, a Wi-Fi® interface, a cellular network interface, and/or the like.

In some implementations, system 980 performs one or more processes described herein. System 980 performs these processes based on processor 910 executing software instructions stored by a computer-readable medium, such as memory 920 and/or storage component 930. A computer-readable medium (e.g., a non-transitory computer readable medium) is defined herein as a non-transitory memory device. A non-transitory memory device includes memory space located inside a single physical storage device or memory space spread across multiple physical storage devices.

In some implementations, software instructions are read into memory 920 and/or storage component 930 from another computer-readable medium or from another device via communication interface 970. When executed, software instructions stored in memory 920 and/or storage component 930 cause processor 910 to perform one or more processes described herein. Additionally or alternatively, hardwired circuitry can be used in place of or in combination with software instructions to perform one or more processes described herein. Thus, embodiments described herein are not limited to any specific combination of hardware circuitry and software unless explicitly stated otherwise.

Memory 920 and/or storage component 930 includes data storage or at least one data structure (e.g., a database and/or the like). System 980 can be capable of receiving information from, storing information in, communicating information to, or searching information stored in the data storage or the at least one data structure in memory 920 or storage component 930. In some examples, the information includes network data, input data, output data, or any combination thereof.

In some implementations, system 980 can be capable of executing software instructions that are either stored in memory 920 and/or in the memory of another device (e.g., another device that is the same as or similar to system 980). As used herein, the term “module” refers to at least one instruction stored in memory 920 and/or in the memory of another device that, when executed by processor 910 and/or by a processor of another device (e.g., another device that is the same as or similar to system 980) cause system 980 (e.g., at least one component of system 980) to perform one or more processes described herein. In some implementations, a module can be implemented in software, firmware, hardware, and/or the like.

The number and arrangement of components illustrated in FIG. 9 are provided as an example. In some implementations, system 980 can include additional components, fewer components, different components, or differently arranged components than those illustrated in FIG. 9. Additionally or alternatively, a set of components (e.g., one or more components) of system 980 can perform one or more functions described as being performed by another component or another set of components of system 980.

Although a few variations have been described in detail above, other modifications or additions are possible. For example, the graphical user interface on the client devices and the spectator devices can include graphical themes. For example, the background colors, images, and visual assets can be modified by an event creator who created the event. This can specialize the event for a given sponsor or occasion. As another variation, the bracket contest 706 shown on the graphical user interface can be automated. For example, the spectator's application can automatically rotate through each live match when exciting moments are determined to be happening via the score and/or the threshold. Each live match can be displayed for a certain amount of time before rotating, such as ten seconds or thirty seconds between each match. Additionally, the spectator's application can show animations, such as an animation when a scoring event occurs or a player wins the match.

As another example, the system can determine a percentage of odds that a given player will win and display this on the spectator's application. The system can access historical data for each player, such as each player's record, statistics, rank, and tendencies. The system can assess the historical data and provide a percentage odds that a specific player will win. In some implementations, the system can update the percentage odds as the live stream event is on-going, assessing both the historical data and current data from the event. In some implementations, the system can use machine learning/artificial intelligence, such as a predictive model, to predict the percentage odds. For example, a machine learning model can be trained based on the historical data and current data from players. The machine learning model can then be used to dynamically predict the outcome and odds associated with the content event. The machine learning model can be updated or otherwise adapted as the match and performance evolves over time. As another example, the process flow depicted in the accompanying figures and described herein do not require the particular order shown, or sequential order, to achieve desirable results. Other embodiments may be within the scope of the following claims.

The subject matter described herein provides many technical advantages. For example, the system describe herein can control the operation of multiple cloud-based applications running on player and spectator client devices to facilitate a live stream of digital content in an integrated and computationally efficient manner. Specifically, by capturing live stream data from the content instances using the player's applications, the system can seamlessly transmit the live stream data to multiple spectator's applications without computational overhead or reliance on a third-party software program. Additionally, by including a load balancer 216 to interface with the player's applications, the system can dynamically balance the network load and resource allocation among the streaming engines 220-226 to reduce performance degradation, latency spikes, and dripped connections. Similarly, the LSS 228 can efficiently direct spectator's applications to the correct streaming engine that is hosting the corresponding live stream events with minimal latency.

The subject matter described herein can also provide capabilities that were not previously possible. For example, this approach can provide spectators with live streams from both player perspectives in a given gameplay session in a centralized location. Additionally, this approach can provide spectators with supplemental data about the gameplay session in real-time, such as game scores, player, performance, in-game events, or other contextual information that are not directly observable from the live stream alone. This data can provide spectators with additional information that can help enhance their understanding for applications such as wagering, tracking player performance, and predictions.

Some implementations of the subject matter can also provide a holistic overview of the entire tournament. Rather than requiring spectators to keep track of multiple live events on the same display, the spectator's application can display a bracket view highlighting a summary of each ongoing match. In some implementations, the spectator's application can provide spectators with additional information, such as highlights and/or clips of key moments from each ongoing match in real-time. As such, this approach can streamline the spectator's experience while watching a content event, such as an online tournament event.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving, from a first client device, data characterizing a first live stream of digital content representing a first content instance operating as part of a first instance of a cloud-based application, the first instance of the cloud-based application executing within an environment specific to the first client device;
receiving, from a second client device, data characterizing a second stream of digital content representing a second content instance operating as part of a second instance of the cloud-based application, the second instance of the cloud-based application executing within an environment specific to the second client device, wherein the first content instance executing on the first client device and the second content instance executing on a second client device include a common gameplay session;
generating a content event based on the common gameplay session, the content event including at least the first live stream of digital content and the second live stream of digital content;
receiving, from a third client device, data characterizing a request to access the content event and an identifier from a third instance of the cloud-based application;
determining, based on the received data from the third content instance, permission to access the content event by at least validating the identifier; and
transmitting, in response to determining permission to access the content event, data characterizing the content event to the third instance for output on a display communicatively coupled to the third client device.

2. The method of claim 1, wherein generating the content event based on the common gameplay session further comprises:
scheduling a match associated with the content event at a scheduled time, the match including the first content instance and the second content instance; and
assigning, at the scheduled time, the first instance to the first instance of the cloud-based application and the second instance to the second instance of the cloud-based application.

3. The method of claim 1, wherein transmitting data characterizing the content event to the third instance further comprises transmitting data characterizing the first live stream of digital content or data characterizing the second live stream of digital content to the third instance for output on the display.

4. The method of claim 1, wherein transmitting data characterizing the content event to the third instance further comprises:
determining, in real-time, a score associated with the content event; and
transmitting the score to the third instance for output on the display.

5. The method of claim 4, wherein the determining the score and transmitting the score is performed continuously for the duration of the content event.

6. The method of claim 1, wherein transmitting data characterizing the content event to the third instance further comprises:
partitioning at least the first live stream of the digital content into a plurality of segments, each of the each of the plurality of segments corresponding to a predefined timeframe;
storing the one or more of the plurality of segments locally in memory; and
transmitting the one or more of the plurality of segments of the first live stream of digital content to the third instance for output on the display.

7. The method of claim 6, further comprising:
deleting the one or more of the plurality of segments from memory after the content event has concluded.

8. The method of claim 6, wherein partitioning at least the first live stream of the digital content into a plurality of segments further comprises:
determining a variation in a score in the content event that satisfies a threshold; and
identifying one or more of the plurality of segments of the first live stream of digital content that corresponds to the variation in the score that satisfies the threshold.

9. The method of claim 1, wherein:
the first content instance corresponds to a first digital game instance operating as part of the first instance of the cloud-based application;
the second content instance corresponds to a second digital game instance operating as part of the second instance of the cloud-based application; wherein the first digital game instance and the second digital game instance include the common gameplay session; and
the third content instance corresponds to an interactive graphical interface operating as part of the third instance of the cloud-based application.

10. The method of claim 9, wherein the interactive graphical interface further comprises a live chat.

11. A system comprising:
at least one data processor; and
memory storing instructions configured to cause the at least one data processor to perform operations comprising:
receiving, from a first client device, data characterizing a first live stream of digital content representing a first content instance operating as part of a first instance of a cloud-based application, the first instance of the cloud-based application executing within an environment specific to the first client device;
receiving, from a second client device, data characterizing a second stream of digital content representing a second content instance operating as part of a second instance of the cloud-based application, the second instance of the cloud-based application executing within an environment specific to the second client device, wherein the first content instance executing on the first client device and the second content instance executing on a second client device include a common gameplay session;
generating a content event based on the common gameplay session, the content event including at least the first live stream of digital content and the second live stream of digital content;
receiving, from a third client device, data characterizing a request to access the content event and an identifier from a third instance of the cloud-based application;
determining, based on the received data from the third content instance, permission to access the content event by at least validating the identifier; and
transmitting, in response to determining permission to access the content event, data characterizing the content event to the third instance for output on a display communicatively coupled to the third client device.

12. The system of claim 11, wherein generating the content event based on the common gameplay session further comprises:
scheduling a match associated with the content event at a scheduled time, the match including the first content instance and the second content instance; and
assigning, at the scheduled time, the first instance to the first instance of the cloud-based application and the second instance to the second instance of the cloud-based application.

13. The system of claim 11, wherein transmitting data characterizing the content event to the third instance further comprises transmitting data characterizing the first live stream of digital content or data characterizing the second live stream of digital content to the third instance for output on the display.

14. The system of claim 11, wherein transmitting data characterizing the content event to the third instance further comprises:
determining, in real-time, a score associated with the content event; and
transmitting the score to the third instance for output on the display.

15. The method of claim 14, wherein the determining the score and transmitting the score is performed continuously for the duration of the content event.

16. The system of claim 11, wherein transmitting data characterizing the content event to the third instance further comprises:
partitioning at least the first live stream of the digital content into a plurality of segments, each of the each of the plurality of segments corresponding to a predefined timeframe;
storing the one or more of the plurality of segments locally in memory; and
transmitting the one or more of the plurality of segments of the first live stream of digital content to the third instance for output on the display.

17. The system of claim 16, further comprising:
deleting the one or more of the plurality of segments from memory after the content event has concluded.

18. The system of claim 16, wherein partitioning at least the first live stream of the digital content into a plurality of segments further comprises:
determining a variation in a score in the content event that satisfies a threshold; and
identifying one or more of the plurality of segments of the first live stream of digital content that corresponds to the variation in the score that satisfies the threshold.

19. The system of claim 11, wherein:
the first content instance corresponds to a first digital game instance operating as part of the first instance of the cloud-based application;
the second content instance corresponds to a second digital game instance operating as part of the second instance of the cloud-based application; wherein the first digital game instance and the second digital game instance include the common gameplay session; and
the third content instance corresponds to an interactive graphical interface operating as part of the third instance of the cloud-based application.

20. The system of claim 19, wherein the interactive graphical interface further comprises a live chat.
